(19) United States
(12) Patent Application Publication
(10) Pub. No.: US 2007/0200676 A1
(43) Pub. Date: Aug. 30, 2007

(54) Method of transmitting an electromagnetic identification request signal to an electronic module mounted on a wheel of a vehicle

(75) Inventors: Olivier Costes, Cugnaux (FR); Helene Garnier, Toulousse (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, Toulouse Cedex 1 (FR)

(21) Appl. No.: 11/710,961

(22) Filed: Feb. 27, 2007

(30) Foreign Application Priority Data
Feb. 28, 2006 (FR) 0601731

(51) Int. Cl. B60C 23/00; H04Q 5/22

(52) U.S. Cl. 340/10.1; 340/447

(57) ABSTRACT

A method is provided of transmitting an electromagnetic identification request signal generated using an antenna connected to a central processing unit mounted on a vehicle, intended for an electronic module mounted on a wheel of the vehicle. By this transmission method, a plurality of identical identification request signals are sent in succession, after the vehicle is started up, and the successive signals are triggered with time intervals having variable durations established by a random determination method.

The invention relates to a method of transmitting an electromagnetic identification request signal generated by means of an antenna connected to a central processing unit mounted on a vehicle, intended for an electronic module mounted on a wheel of said vehicle.

Motor vehicles are increasingly being fitted, for safety purposes, with monitoring systems comprising sensors mounted on each wheel of the vehicle, dedicated to measuring parameters, such as pressure or temperature of the tires fitted on these wheels, and intended to inform the driver of any abnormal variation in the measured parameter.

These monitoring systems are conventionally provided with an electronic module mounted on each wheel of the vehicle, incorporating, in addition to the abovementioned sensors, a microprocessor and a radiofrequency transmitter (or RF transmitter), and a central processing unit for receiving signals sent by the transmitters, comprising a computer incorporating a radiofrequency receiver (or RF receiver) connected to an antenna.

One of the problems to be resolved with such monitoring systems lies in the need to have to associate with each signal received by the receiver of the central processing unit an indication concerning the location of the electronic module and therefore the wheel originating this signal, this obligation continuing throughout the life of the vehicle, that is, having to be respected even after wheel changes or more simply reversal of the positions of these wheels.

At the present time, a first locating method consists in using three low-frequency antennas, each positioned in the immediate vicinity of one of the wheels of the vehicle, and in performing a locating procedure consisting in successively exciting each of these three antennas by transmitting a low-frequency magnetic field.

According to this procedure, the electronic module mounted on the wheel located in the vicinity of the excited antenna orders, in response and intended for the central processing unit, the transmission of a low-frequency signal containing a code identifying said module, such that the successive excitation of the three antennas leads to the locating of the three modules mounted on the wheels adjacent to these antennas, and, by deduction, to the locating of the fourth module.

The main advantage of such a method lies in the fact that the locating procedure is very fast and results in a quasi-instantaneous location after the vehicle is started up.

However, this solution requires the vehicle to be fitted with three antennas with all the attendant needs for connecting cables, control amplifiers, such that it can prove costly.

This drawback relating to the cost of installing means of implementing the locating method can be resolved when the vehicle is fitted with a hands-free access device intended to allow access to said vehicle and the starting up of the latter.

In practice, the solution then consists, as in particular described in patent application WO 02/051654, in using the transmitting antennas of this hands-free access device mounted on the vehicle to implement the wheel locating procedure.

As described in the abovementioned patent application, implementing this solution consists, for example, in ordering the transmission by the transmitting antennas of an uncoded signal when said antennas are used to locate the wheels, and in ordering the transmission of a coded signal when the antennas are used for their original vehicle access control purpose.

Such a solution does, however, present a major drawback resulting from the fact that the antennas of the hands-free access devices are not positioned ideally with a view to locating the wheels of a vehicle.

In practice, the positioning of the antennas, designed to optimize the operation of the hands-free access system, leads to the creation, when the wheels and therefore the electronic modules fitted on the latter are rotating, of angular areas where these electronic modules do not receive signals sent by these antennas.

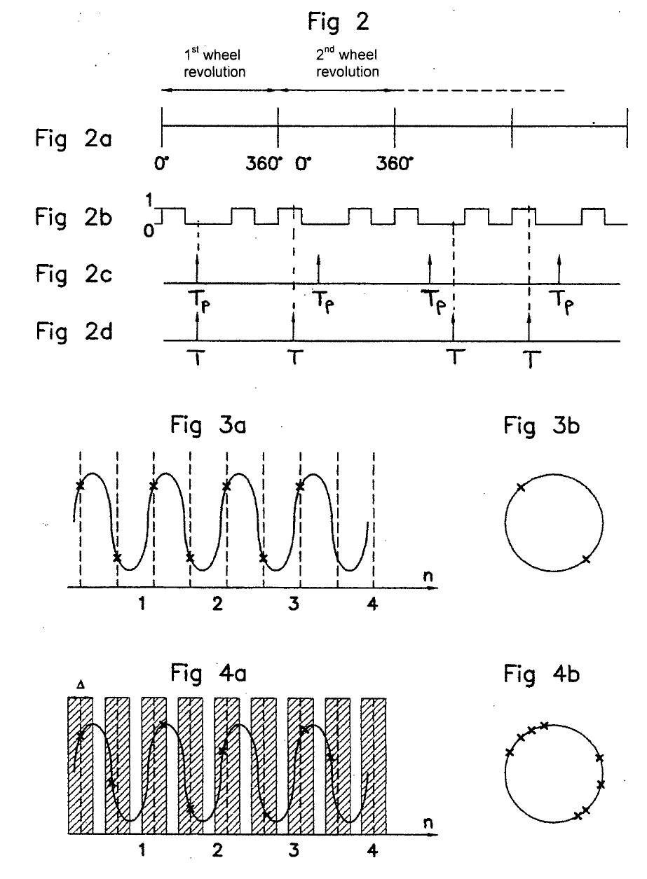

The existence of these non-reception areas is revealed by analyzing FIGS. 2a and 2b which illustrate the results of measurements of reception, by an electronic module mounted on a front right wheel of a vehicle, of the electromagnetic signals transmitted periodically by an antenna mounted on the handle of the front right door of this vehicle. In light of this illustration, these figures respectively represent, in projection on a horizontal axis:
the path described by an electronic module mounted on a wheel (FIG. 2a),
and the corresponding areas (level 0 of the signal represented in FIG. 2b) of non-reception by this module of the electromagnetic signals transmitted by the antenna.

It clearly emerges from these figures that the electronic module that is the subject of the test carried out, is, at given times, located in areas of non-reception of the signals transmitted by the antenna responsible for transmitting the identification request signals intended for said module.

Because of this, the reception of the identification signals by the electronic modules becomes hypothetical, and it is impossible to control the time required to perform a complete wheel locating procedure, even to guarantee the successful completion of this procedure.

The present invention seeks to overcome this drawback, and its main objective is to provide a transmission method that is very powerful in terms of responsiveness and reliability.

To this end, the subject of the invention is a method of transmitting an electromagnetic identification request signal generated by means of an antenna connected to a central processing unit mounted on a vehicle, intended for an electronic module mounted on a wheel of said vehicle, this transmission method:
consisting in sending in succession, after the vehicle is started up, a plurality of identical identification request signals (S1 . . . , Si, Si+1, . . . ),
and wherein said transmission method consists in triggering the successive signals with time intervals having variable durations established by a random determination method.

It should be noted that, according to the invention, the term “electromagnetic signal” is used to encompass generally the low frequency “LF” signals and the radiofrequency “RF” signals.

The transmission method according to the invention makes it possible to overcome the problems posed by the non-reception areas by applying a random determination method suitable for varying the time intervals separating the successive transmissions of the electromagnetic signals.

Such a method, which consists in applying a random time shift between the successive triggerings of an identification request signal, leads, in practice, to the shifting of the relative angular position of an electronic module relative to the transmitting antenna associated with said module, and thus ensures, regularly and with a high frequency, that this electronic module will be positioned in a reception area, and consequently a rapid successful completion of the locating procedure.

Furthermore, such a solution consists of a purely “software” solution, such that it generates no production cost overhead.

Finally, since the transmission method according to the invention covers up the problem of the non-reception areas, it makes it possible to ensure a rapid locating of the wheels of a vehicle by using, to transmit the identification request signals, the antennas of the hands-free access device fitted on this vehicle.

According to a first advantageous embodiment of the invention, the durations of the time intervals are determined by a random calculation using a dynamic variable as basic variable of said random calculation.

This first solution consists in applying a conventional-type random calculation, known per se, by using a dynamic variable as basic variable.

According to a second advantageous embodiment of the invention, the durations of the time intervals are determined by a pseudo-random calculation method consisting in randomly choosing a value from a predetermined number of preselected duration values.

Furthermore, whatever the abovementioned random calculation method applied, the transmission method according to the invention advantageously consists in determining the durations of the time intervals by adding to a predetermined fixed time period a random duration established by a random determination method.

Other characteristics, aims and advantages of the invention will become apparent from the detailed description that follows with reference to the appended drawings which represent, by way of non-limiting example, a preferred embodiment thereof. In these drawings:

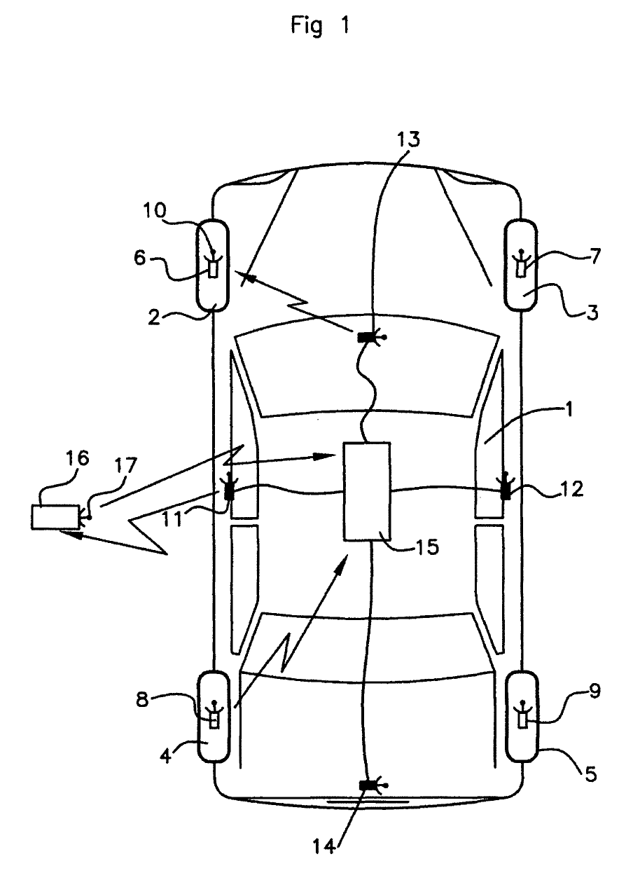

FIG. 1 is a diagrammatic top view of a vehicle provided with a monitoring system comprising a device for locating the wheels of said vehicle implementing the transmission method according to the invention,

FIGS. 2a to 2d are four graphs intended to illustrate the transmission method implemented according to the invention, and making it possible to compare, for a constant vehicle speed, the results obtained on implementing this method, illustrated in FIG. 2d, with the results obtained on periodic transmissions of the electromagnetic signals,

FIGS. 3a and 3b consist of two other graphic representations illustrating the results obtained, for a constant vehicle speed, on periodic emissions of the electromagnetic signals,

and FIGS. 4a and 4b consist of two graphic representations similar to those of FIGS. 3a and 3b, illustrating the results obtained on implementing the method of the invention.

The monitoring system implementing the transmission method according to the invention is shown, in FIG. 1, mounted on a vehicle 1 provided with four wheels conventionally fitted with a tire: two front wheels 2, 3 and two rear wheels 4, 5.

Such monitoring systems conventionally comprise, firstly, associated with each wheel 2-5, an electronic module 6-9, connected for example to the rim of said wheel in such a way as to be positioned inside the enclosure of the tire.

Each of these electronic modules 6-9 incorporates, for example, sensors dedicated to measuring parameters, such as pressure and/or temperature of the tire, connected to a microprocessor having an identification code of said module, and connected to an RF transmitter connected to a low-frequency antenna such as 10.

The monitoring system also comprises a centralized computer or central processing unit 15 including a microprocessor and incorporating an RF receiver designed to receive the signals transmitted by each of the four electronic modules 6-9, and connected, for this purpose, to an antenna (not shown).

Normally, such a monitoring system, and in particular its central processing unit 15, is designed to inform the driver of any abnormal variation in the parameters measured by the sensors associated with the wheels 2-5.

The monitoring device according to the invention also comprises transmitting antennas 11-14 connected to the central processing unit 15 and made up of the antennas of a device usually known as “hands-free access device”, designed to make it possible to access the vehicle 1 and to start up the latter by identifying an electronic badge 16.

According to the provisions of such a hands-free access device, there are four of these antennas, respectively consisting of:
a left antenna 11 positioned on the handle of the front left door of the vehicle,
a right antenna 12 positioned on the handle of the front right door of the vehicle,
a front antenna 13 positioned on the dashboard of the vehicle,
and a rear antenna 14 positioned on the handle of the door of the trunk of the vehicle.

As for the electronic badge 16 of this hands-free access system, it conventionally comprises a computer incorporating a low-frequency “LF” receiver and a radiofrequency “RF” transmitter connected to antennas such as 17.

Usually, and in order to locate the wheels 2-5 of the vehicle 1, the central processing unit 15 is programmed, after said vehicle is started up and for each of the antennas 11-14 used for this locating procedure, to transmit n successive identical electromagnetic identification request signals S1, . . . Si, Si+1, . . . Sn.

According to the invention, these n successive signals are transmitted with time intervals having variable durations established by a random determination method.

More specifically, the duration of these time intervals is obtained by adding to a predetermined fixed time period a random duration established by a random determination method.

Furthermore, this random determination method can, according to the invention, consist in determining the random durations of the time intervals:
either by a random calculation using a dynamic variable as the basic variable of said random calculation,
or by a pseudo-random calculation method, consisting in randomly choosing a value from a predetermined number of preselected duration values.

Thus, by way of numerical examples:
each fixed time period can have an order of magnitude that can be expressed in hundreds of milliseconds: for example 200 ms or 300 ms,
and the random durations can be within a range A of the order of a few tens of milliseconds: for example, a range extending between 0 ms and (m×10) ms, or a range extending between (−n×10) ms and (+n×10) ms.

Such a transmission method therefore consists in obtaining a random time shift between the successive triggerings of an identification request signal.

According to this principle, as shown in FIG. 2d taken in association with FIGS. 2a and 2b, when a “pulse” T transmitting an electromagnetic signal occurs when the electronic module of the wheel concerned is located in a non-reception area, this time shift rapidly ensures that a future transmission pulse T will be transmitted when the module is in a reception area and, consequently, ensures the reception by said module of an identification request signal and the return transmission by the latter of its identification code.

The advantages of the invention can also be seen by analyzing FIGS. 3a, 3b, 4a and 4b which illustrate that, after a few wheel revolutions:
in the case of a periodic transmission Tp of the electromagnetic signals (FIGS. 2c, 3a and 3b), the number of sampling points on the circumference of the wheel is equal to the number of triggerings during a wheel revolution,
in the case of a transmission, according to the invention (FIGS. 2d, 4a and 4b), with time intervals of random durations, the sampling points on the circumference of the wheel cover angular areas of this wheel, that is, angular segments and no longer points.

Thus the transmission method according to the invention ensures a rapid locating of the wheels of a vehicle by using the antennas of the hands-free access device fitted on this vehicle to transmit the identification request signals.

1. A method of transmitting an electromagnetic identification request signal generated by means of an antenna (11-14) connected to a central processing unit (15) mounted on a vehicle (1), intended for an electronic module (6-9) mounted on a wheel (2-5) of said vehicle, this transmission method consisting in sending in succession, after the vehicle (1) is started up, a plurality of identical identification request signals (S1 . . . , Si, Si+1, . . . ), and wherein said transmission method consists in triggering the successive signals with time intervals having variable durations established by a random determination method.

2. The transmission method as claimed in claim 1, wherein the durations of the time intervals are determined by a random calculation using a dynamic variable as basic variable of said random calculation.

3. The transmission method as claimed in claim 1, wherein the durations of the time intervals are determined by a pseudo-random calculation method consisting in randomly choosing a value from a predetermined number of preselected duration values.

4. The transmission method as claimed in claim 1, wherein the durations of the time intervals are determined by adding to a predetermined fixed time period a random duration established by a random determination method.

5. The transmission method as claimed in claim 2, wherein the durations of the time intervals are determined by adding to a predetermined fixed time period a random duration established by a random determination method.

6. The transmission method as claimed in claim 3, wherein the durations of the time intervals are determined by adding to a predetermined fixed time period a random duration established by a random determination method.
